(19) United States
(12) Patent Application Publication
(10) Pub. No.: US 2019/0111955 A1
(43) Pub. Date: Apr. 18, 2019

(54) DOOR ASSEMBLY FOR TRANSPORT ROBOT

(71) Applicant: Savioke, Inc., San Jose, CA (US)

(72) Inventors: Adrian Canoso, Sunnyvale, CA (US); Steven Cousins, San Jose, CA (US)

(73) Assignee: Savioke, Inc., San Jose, CA (US)

(21) Appl. No.: 15/787,584

(22) Filed: Oct. 18, 2017

(51) Int. Cl. B62B 3/00; E05F 15/73

(52) U.S. Cl. CPC B62B 3/004; G05D 1/0274; Y10S 901/01; E05F 15/73

(57) ABSTRACT

Disclosed are technologies for robotic transport of one or more items of payload, including a configurable door assembly for a storage compartment of a robot.

### FIELD OF THE DISCLOSURE

The present disclosure relates to mobile digital computer controlled robots that can autonomously navigate a physical environment, such as a building, to transport items from one location to another, and more particularly to a door assembly for a storage compartment of a transport robot.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Some robots, such as those designed and manufactured by Savioke, Inc. of San Jose, Calif., are mobile. Mobile robots can be programmed to perform transport tasks within a geographic and/or spatial area having a perimeter that is defined by a boundary. Examples of defined areas include buildings, rooms and floors of buildings, and groups of buildings, such as hotels, office complexes, and hospital campuses. Mobile robots can be programmed to perform transport tasks autonomously or semi-autonomously.

### BRIEF DESCRIPTION OF THE DRAWINGS

In the drawings:

FIG. 1 is a simplified block diagram of a networked environment in which a mobile robot having a configurable door assembly may operate, according to at least one embodiment.

FIG. 2 is a simplified flow diagram of an example process for configuring a door assembly of a transport robot, according to at least one embodiment.

FIG. 3A is a simplified perspective view of a side of a robot, showing one configuration of a door assembly and an interior region of a storage compartment, including components of the interior region shown in phantom.

FIG. 3B is a simplified perspective view of the side of the robot of FIG. 3A, showing another configuration of the door assembly and an interior region of a storage compartment, including components of the interior region shown in phantom.

FIG. 3C is a simplified perspective view of the side of the robot of FIG. 3A, showing another configuration of the door assembly and an interior region of a storage, including components of the interior region shown in phantom.

FIG. 4A is a simplified top view of the robot of FIG. 3A, showing components of the door assembly in phantom.

FIG. 4B is a simplified front elevational view of the side of the robot shown in FIG. 3A, showing another configuration of the door assembly including portions of horizontal doors shown in phantom and an interior region of a storage compartment.

FIG. 4C is a simplified front elevational view of the side of the robot shown in FIG. 3A, showing another configuration of the door assembly including portions of vertical doors shown in phantom and an interior region of a storage compartment.

FIG. 5 is a simplified block diagram that illustrates a computer system in connection with which portions of at least one embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In some instances, structures and devices are shown in block diagram form in order to avoid unnecessarily obscuring the present invention.

General Overview

To execute a transport task, a mobile robot may utilize automated navigation and mapping technologies. Sensors on the robot or located in a physical environment are used to collect data about the physical environment. Mapping technologies use the collected sensor data to create and update maps of a defined area of the physical environment. The mapping technologies are implemented in the robot and/or computers that can communicate electronically with the robot. Maps generated by the mapping technologies include digital data that describe a geographic and/or spatial layout of the defined area.

Task planning technologies can use the maps and other digital information to create a route for the robot to travel through the defined area, from an origin location to a destination location, in order to perform a task. Task planning technologies are implemented in the robot and/or computers that can communicate electronically with the robot.

To perform navigation, the robot is equipped with one or more sensors that, during operation of the robot, collect data about the physical environment surrounding the robot. Localization and navigation technologies (such as SLAM—simultaneous localization and mapping) use the digital maps and the sensor data to computationally determine the robot's two or three-dimensional spatial position and orientation with respect to the mapped area, at time intervals, during operation of the robot. The localization and navigation technologies may include, for example, computer-implemented visual odometry algorithms.

Using the data indicating the robot's current spatial position and orientation with respect to the digital map, the navigation technologies interface with the robot's control system to initiate electromechanical processes, such as sending power to the robot's motor or pivoting the robot's wheels in a certain direction, which cause the robot to travel along the defined route in accordance with certain constraints that may be defined for a particular transport task.

Previously existing capabilities of robots for performing multi-delivery transport tasks involving multiple different types of payload are limited. Many current robots can only perform one delivery before returning to a base station. To address these and other shortcomings of the prior solutions, the technologies described in this disclosure provide a door assembly that can be specially configured for access-controlled and/or multi-delivery robotic transport tasks. The disclosed door assembly can be especially suitable when the robot's payload includes access-controlled items and/or a mixture of differently-sized or differently-shaped items.

The disclosed technologies enable the robot to deliver multiple differently-shaped or differently-sized items to multiple different recipient destinations on a single trip. In this way, the disclosed technologies allow the robot to perform transport tasks that previously would have been considered too complicated for the robot to perform. Additionally, the disclosed technologies can specially configure transport tasks to implement the specific access control requirements of individual items in the robot's payload.

Examples of robotic transport tasks that can involve multiple deliveries or a variety of differently-sized or differently-shaped payload include pizza or meal delivery, delivery of bagged groceries or supplies, and delivery of a combination of small and large items, such as a pizza box and soda cans. The technologies described in this document enable these and other types of transport tasks to be performed by mobile robots with improved efficiency.

The disclosed technologies can be implemented to improve robotic transport of access-controlled items in many applications, including health care. In a health care facility, such as a hospital, surgical center, acute care facility, or long-term care facility, the disclosed technologies can be used to provide secure healthcare-based robotic transport services, by enabling storage compartments to be specially configured to carry sensitive items such as medications, biological samples, fluids intended for intravenous delivery (IV bags), patient waste, blood samples, food, and gift items. The word secure and similar terminology may be used in this disclosure to refer to adherence of an object, device, or process to a set of requirements, policy or protocol for security or access control.

As used in this disclosure, the term access-controlled and similar terminology may refer to, for example, any mobile item whose location and/or custody is monitored or tracked over time for adherence to a defined set of requirements, policy or protocol, or the process of executing such monitoring and tracking. For instance, a security or access control policy implemented in the robot for a transport task for prescription medications may require individual medications to be stored in separate storage compartments within the robot. Additionally, a security or access control policy implemented in the robot for a transport task for pizza may require an insulated storage compartment that has larger length and width dimensions but a smaller height dimension than is used for other types of payload. Terms such as custody, as used in this disclosure, may refer to, for example, the act or process of carrying or holding an item at least temporarily, by a person or a piece of equipment or a machine, such as a robot.

An item or set of items being carried by a robot may be referred to herein as a payload of the robot. A payload or any individual item or set of items in the payload can have several attributes. An example of an item attribute is item name, such as the name of a medication or a food item, or a unique identifier. Another example of an item attribute is a descriptive label, such as a category like food, narcotic, or supplies. Other examples of item-specific attributes include, for medications, prescribing physician, patient name, dosage, formulation, and quantity. Other examples of item attributes are special handling requirements, such as whether the item needs refrigeration or heating to maintain a specific temperature, special delivery requirements such as a maximum time in transit, access restrictions, use or expiration times or dates, patient identifying information, origin identifying information, and destination identifying information. Different access restrictions or levels of restriction may be some of the inputs used by a computer to determine the configuration of the storage compartments and the corresponding configuration of doors of the door assembly.

Networked Computing Environment

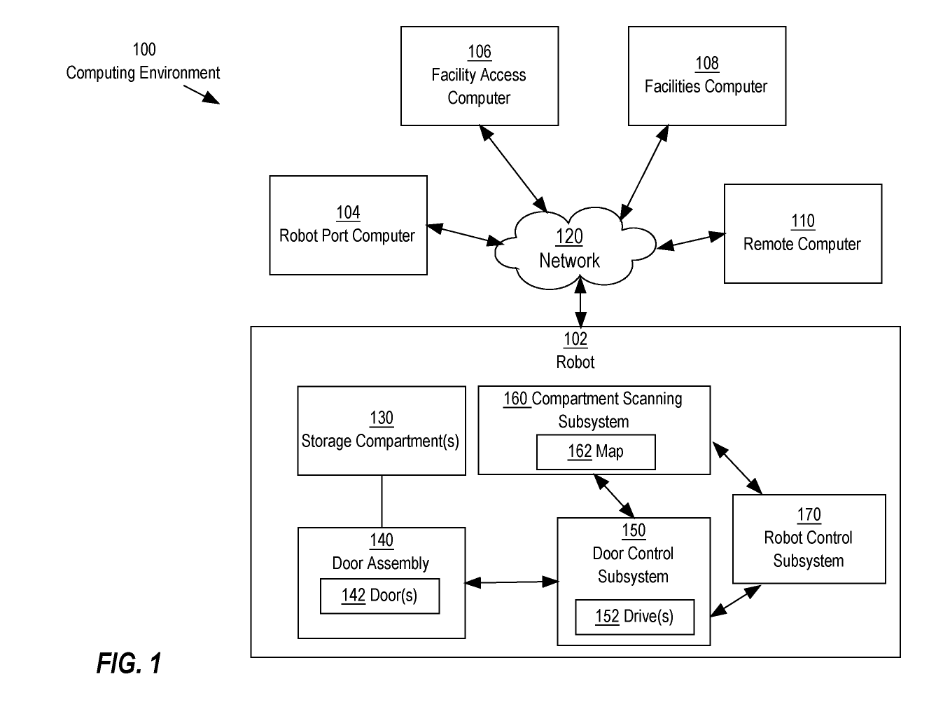

FIG. 1 illustrates an example networked computing environment in which a robot may operate, according to various embodiments. In FIG. 1, certain computing infrastructure is arranged to support operation of a robot 102. The illustrative computing environment 100 comprises the robot 102, a robot port computer 104, a facility access computer 106, a facilities computer 108, a remote computer 110, and an electronic communications network 120. The example robot 102 is equipped with a robot control system 170, one or more storage compartments 130, a door assembly 140, a door control subsystem 150, and a compartment scanning subsystem 160.

This disclosure describes structure of and functionality performed by components of the computing environment 100, including robot 102, robot port computer 104, facility access computer 106, facilities computer 108, remote computer 110, electronic communications network 120, robot control system 170, storage compartment(s) 130, door assembly 140, door control subsystem 150, and compartment scanning subsystem 160. Portions of the disclosed functionality are implemented in electronics, electromechanical and mechanical assemblies, and as processor-executable instructions implemented in computer hardware, computer software, or a combination of hardware and software.

Capabilities described in this document as being performed by one or more of the computers 104, 106, 108, 110, network 120 or robot 102 can be implemented entirely in the robot 102, in some embodiments. Similarly, capabilities described in this document as being performed by the robot 102 may be at least partially implemented using other components of the computing environment 100, in other embodiments.

Moreover, features described in this document are useful in robots as well as other devices. For instance, features of the disclosed storage compartment(s) 130, door assembly 140, door control subsystem 150, and/or compartment scanning subsystem 160 can be used in other applications. In one alternative embodiment, at least door assembly 140 is used in a storage device, such as a storage locker that is used to store packages or other items.

In an embodiment, the computers 104, 106, 108, 110 and the robot 102 are bidirectionally communicatively coupled to the network 120. Network 120 broadly represents any combination of one or more local area networks, wide area networks and internetworks using any of wired, wireless, terrestrial or satellite links. The computers 104, 106, 108, 110 may be local to a building or campus in which the robot 102 is deployed. In some embodiments, remote computers or virtual computing instances in networked datacenters may be included in the computing environment 100, and portions of the described data and/or functionality may be stored in or executed by an Internet-accessible network of server computers such as a public or private cloud.

When computers within the computing environment 100 are local, they may be physically present in the building in which the robot 102 is to operate. In some embodiments, one or more components of the computing environment 100 may communicate over the network 120 with other computing systems, such as an enterprise asset tracking system or a workflow monitoring system.

In the example of FIG. 1, computing environment 100 includes a robot port having a robot port computer 104. The robot port comprises a device in which, or next to which, robot 102 returns when the robot is not in use. In an embodiment, the robot port may include electronic connections to which the robot 102 can automatically connect for network communication or power, such as to charge a battery of robot 102. For example, robot 102 and robot port may be structured to enable the robot 102 to automatically contact the power connections when the port is reached or mechanically engaged.

The example facilities access computer 106 provides robot 102 with access to data pertaining to features of the mapped area in which the robot is to operate. The facilities access computer 106 may provide an application programming interface (API), which the robot 102 is programmed to call with instructions and data configured to instruct the facilities access computer 106 to operate elevators, request operation of electronic doors, or control security sensors. Facilities access computer 106 may communicate with other electronic systems within mapped area such as elevators, door locks, door opening systems, security sensors, and the like.

The example facilities computer 108 is programmed with supervisory functions for robots 102, and provides an interface for an operator to communicate with the robot. The facilities computer 108 may be programmed to respond to electronic requests made by robot 102 during the robot's execution of autonomous mapping procedures. The facilities computer 108 may control deployment of robot 102 on pick-ups, deliveries, or other transport tasks.

The facilities computer 108 may provide robot 102 with access to data indicative of the location of temporary obstacles in the mapped environment. Examples of such data include locations of holiday decorations, large crowds, and temporary installations.

Facilities computer 108 may be programmed to receive and provide robot 102 with access to data from sensors positioned in or around the mapped area including, for example, moisture sensors, smoke detectors, security cameras, and the like. Additionally, facilities computer 108 may provide robot 102 with access to data describing the time and location of scheduled events affecting the mapped area, such as carpet cleanings, irrigation schedules, and ongoing construction. Any data mentioned in this disclosure may be maintained in a persistent memory or database and may be associated with an anticipated expiration date and/or time. Any such data may be communicated electronically to robot 102 by any suitable method of electronic communication, including wireless communications.

Robot

In the example of FIG. 1, robot 102 is an autonomous, mobile, battery-powered electro-mechanical robot under control of a programmed digital computer, which may be entirely or partially contained in the robot. Some data or functionality of robot 102 may be achieved by the robot communicating with another computer over the network 120. The robot 102 moves, relative to its surrounding environment, using a propulsion or mobility subsystem 340, which may be implemented as a set of motorized wheels mounted on a bottom surface of the robot and which are communicatively coupled to the robot's control subsystem 170. The illustrative robot 102 is designed to engage with the physical floor of a facility, but other versions of robot 102 (such as aerial vehicle implementations, like drones) may utilize portions of the disclosed technologies equally as well. The robot 102 may propel itself at velocities that are appropriate to its environment, for example at a human walking speed or slower. In some embodiments, robot 102 may adjust its speed based on conditions of the physical environment in which it is operating. The wheels or other propulsion mechanism implemented in robot 102 may be selected for performance in a variety of indoor and outdoor environments, including adaptability for different surfaces such as tile, carpet, and concrete.

The example robot 102 includes one or more input devices, which may include a touchscreen that provides a graphical user interface (GUI) to communicate messages to humans. Robot 102 may be programmed to generate instructions or execute actions in response to input received via the touchscreen. For example, input received via the touchscreen may include authenticating information of a person who is authorized to receive a delivery of a transported item, such as a passcode or a digital picture of the person. Robot 102 may include other input mechanisms such as a keypad or keyboard, buttons, switches, audio sensors for voice commands, microphones, video cameras, or other readers or sensing devices.

The example robot 102 is equipped with sensors, which the robot 102 may use to obtain sensor data indicative of characteristics, activity, or status of, on or in the robot and/or its surrounding physical environment. Exemplary types of sensors that may be implemented on or in the robot 102 include laser sensors, Light Detection and Ranging (LIDAR) position or motion sensors, force sensors, pressure sensors, three-dimensional (3D) cameras, color cameras, barometers, altimeters, accelerometers, and others. Robot 102 may analyze sensor data obtained from any of its sensors and execute programming logic to make determinations or decisions, such as navigation decisions, event detection determinations, and control decisions. For example, robot 102 may use sensor data to detect a door-related event, such as a request or an attempt to open or close a door to one or more of the storage compartments 130, or to detect a payload in or adjacent to a storage compartment of the robot, or to detect that an item of payload has been placed in the correct or incorrect storage compartment.

The example robot 102 is equipped with one or more network interfaces configured to communicate with the computers and systems of the computing environment 100. In some embodiments, robot 102 is equipped with shorter-range wireless electronic communication capabilities, which robot 102 uses to communicate with mobile electronic devices, including smartphones, tablet computers, wearable devices, or Internet of Things (IoT) devices. For example, robot 102 may receive an electronic communication from a mobile device associated with a person who is authorized to receive delivery of an item, and in response to the electronic communication, cause door control subsystem 150 to execute an algorithm to validate the electronic communication and unlock the storage compartment 130 when robot 102 or door control subsystem 150 has validated the electronic communication.

The network interfaces implemented in robot 102 may utilize any suitable wired, wireless, or optical networking technology, including Ethernet, Wireless Fidelity (WIFI), 3G and/or 4G modems, Bluetooth, infrared (IR), radio frequency (RF), near-field communication (NFC), and low-bandwidth radio. In some embodiments, robot 102 is equipped with a Global Positioning System (GPS) receiver, which it uses to determine its geographic location.

Storage Compartments—Configuration

In FIG. 1, the example robot 102 comprises one or more storage compartments 130, a door assembly 140, a door control subsystem 150, a compartment scanning subsystem 160, and a robot control subsystem 170. The door control subsystem 150, compartment scanning subsystem 160 and robot control subsystem 170 comprise processor-executable instructions that are implemented in computer software, hardware, or a combination of hardware and software and stored in memory or data storage of the computing environment 100.

In general, the robot control subsystem 170 coordinates and controls execution of and communications between compartment scanning subsystem 160 and door control subsystem 150, and communicates electronically with other electronic and/or electromechanical components of robot 102 and/or computing environment 100 to control the operation of robot 102 in response to various inputs as needed. Illustrative embodiments of storage compartment(s) 130, door assembly 140, compartment scanning subsystem 160, and door control subsystem 150 are described in more detail below.

The example robot 102 is equipped with one or more storage compartments 130. The storage compartment 130 may include sub-compartments (or “cells”), and each compartment or sub-compartment may be adjustably sized to hold items that are appropriate to the particular environment or the particular application for which robot 102 is being used. For example, in hospitality applications, storage compartment 130 may be adjusted to permit carrying any of: linens; toiletries; medications; magazines and reading materials; lost and found items such as wallets, keys, and personal electronic devices. In hospital or health care facility applications, storage compartment 130 may be adjusted to carry, for instance, medications, biological samples, first aid items, medical devices, supplies, and/or food.

In some embodiments, dimensions of sub-compartments of the storage compartment 130 can be adjusted dynamically to accommodate a variety of differently-sized or differently-shaped payload items. To do this, the storage compartment 130 comprises a set of user- or machine-configurable shelf members (for example shelves and vertical spacers), which are removably mounted within the storage compartment 130 by fixed mounts (such as notches or grooves defined within the shelves, vertical shelf members or storage compartment housing) or adjustable-position mounts (such as movable supports, brackets, or pins).

Sizing or re-sizing of the sub-compartments can be performed manually or by a machine (such as the robot 102). Parameters for sizing or re-sizing of the sub-compartments (such as length, width, and depth dimensions of the sub-compartments or two- or three-dimensional coordinates of the corners of the sub-compartments) can be specified or determined based on the expected payload for the sub-compartment or for the entire transport task or set of transport tasks (for example based on all of the expected payloads involved in the task or tasks).

Once the storage compartment 130 has been configured (either by human or by machine) with the desired arrangement of shelf members (shelves and/or vertical spacers), compartment scanning subsystem 160 registers the storage compartment configuration so that robot 102 has access to the data that defines the position and size (dimensions) of the storage compartment 130 including any sub-compartments.

To do this, a sensor (such as a camera and/or other sensors mounted to robot 102) scans the storage compartment and compartment scanning subsystem 160 uses data extracted from the sensor signals to map the location of each shelf member (shelf and/or vertical spacer) to corresponding locations on a grid using a coordinate system, such that a corner (defined by, for example, an intersection of two shelf members) of a sub-compartment of the storage compartment 130 is associated with two-dimensional (x, y) or three-dimensional (x, y, z) coordinates. The resulting map 162 of the storage compartment 130 is stored in computer memory that is accessible to robot 102.

In some embodiments, the map 162 of the storage compartment 130 is supplemented with information about payload that can be carried within each sub-compartment. For instance, a mapping table or database (or other suitable form of data structure or computer programming construct that can be used to establish relationships between different data items) may be generated and stored in computer memory, which associates different types or attributes of payload or different items of payload with different sub-compartments or dimensions of sub-compartments defined within the storage compartment.

In operation, robot 102 uses the map 162 to control access to the sub-compartments of the storage compartment 130. For example, when an item to be loaded into the storage compartment 130 is detected, robot 102 uses the map 162 to determine which sub-compartment to open. Once robot 102 has determined the appropriate sub-compartment to open, door control subsystem 150 operates door assembly 140 to cause the appropriate sub-compartment to be opened for loading of payload, by causing one or more doors 142 of the door assembly 140 to move in a direction relative to the storage compartment 130 to open the sub-compartment for loading.

When robot 102 detects that a sub-compartment is successfully loaded, robot 102 or door control subsystem 150 causes door assembly 140 to move the one or more doors 142 of door assembly 140 in an opposite direction from the direction in which the door(s) were moved to open the sub-compartment (to close the sub-compartment after loading). Robot 102 repeats the process for each sub-compartment that needs to be loaded before initiating a transport task. When all items needing transport during a task have been loaded, robot 102 proceeds with the transport task.

The unloading process works similarly. When robot 102 detects that a sub-compartment is to be unloaded (for example, by arrival of robot 102 at a destination location), robot 102 or door control subsystem 150 causes door assembly 140 to move the one or more doors of door assembly 140 in a direction to open the sub-compartment. Robot 102 repeats the process for each sub-compartment that needs to be unloaded before completing the transport task. When all items needing delivery during a task have been unloaded, robot 102 may perform the next transport task in a multi-delivery task, or may receive a new task, or may return to a base station.

Door Assembly Configuration and Control

The storage compartments and sub-compartments 130 are coupled to a door assembly 140, which includes one or more doors that are movable (such as retractable) linearly across an opening to the storage compartment, where movement of the doors is controlled by one or more drive mechanisms 152 (such as electric motors or linear actuators). For example, movement of a door may be controlled by its own drive mechanism or a drive mechanism may control multiple doors 142.

In one embodiment, door assembly 140 comprises two sets of curtain- or shade-style doors, with each set comprising two coplanar doors coupled to opposite ends of storage compartment 130 and movable along the same axis, such that one set of doors moves along the horizontal or x axis while the other set of doors moves along the vertical or y axis, relative to the storage compartment 130. The sets of doors are disposed in parallel planes. For example, the set of doors that move along the x axis may be disposed in a plane that is adjacent to and parallel to the plane in which the set of doors that move along the y axis are disposed.

The doors 142 are configured to retract into the storage compartment (such as in an accordion-like fashion or by rotating about a roller) by movement in one direction along the assigned axis and extend across an otherwise-exposed side of the storage compartment 130 by movement in the direction that is opposite the direction of retraction. Doors of door assembly 140, as well as shelves and vertical shelf members of storage compartment 130, can be manufactured using, for example, a woven synthetic material (such as an aramid or para-aramid synthetic fiber like KEVLAR) or similar type of material, metal or plastic, alone or in combination with an elastic fabric. In some embodiments, door-mounted sensors (such as cameras or infrared sensors) are used to detect the location and/or spatial orientation of shelves and vertical shelf members within storage compartment 130 and report that information to robot 102 (such as for creation of a map of storage compartment 130).

In one embodiment, leading edges of the moveable/retractable doors of door assembly 140 are configured with obstacle or obstruction detection sensors (such as motion or heat sensors) mounted to the leading edge and at the point of retraction (such as mounted to the roller or to a portion of interior housing of the storage compartment 130 into which the door retracts). In some embodiments, door assembly 140 is equipped with light source(s) (such as light emitting diodes or LEDs), which are mounted to door assembly 140 so as to supply visible-light illumination into storage compartment 130, so as to provide visibility to the contents of storage compartment 130 or the sub-compartments.

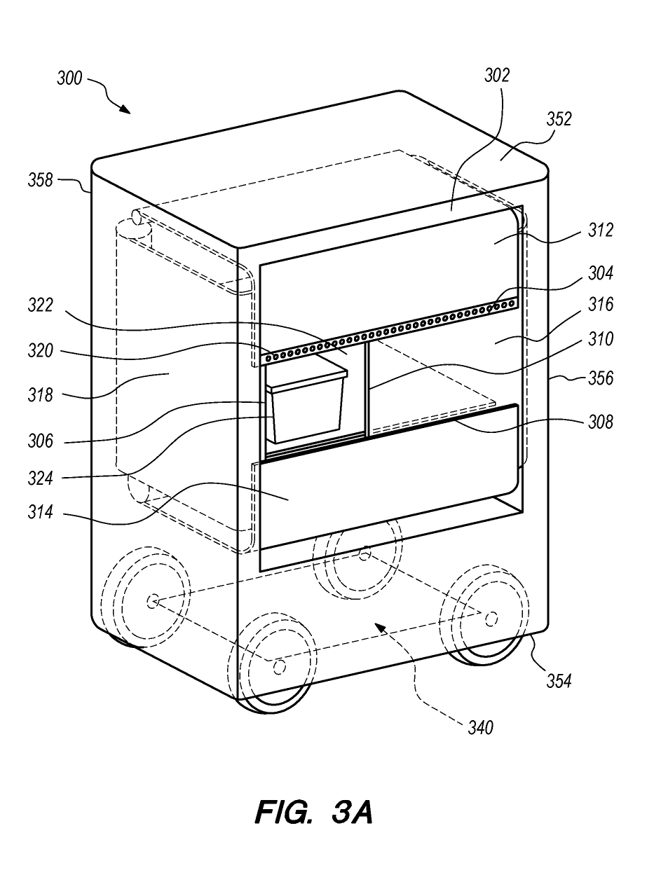

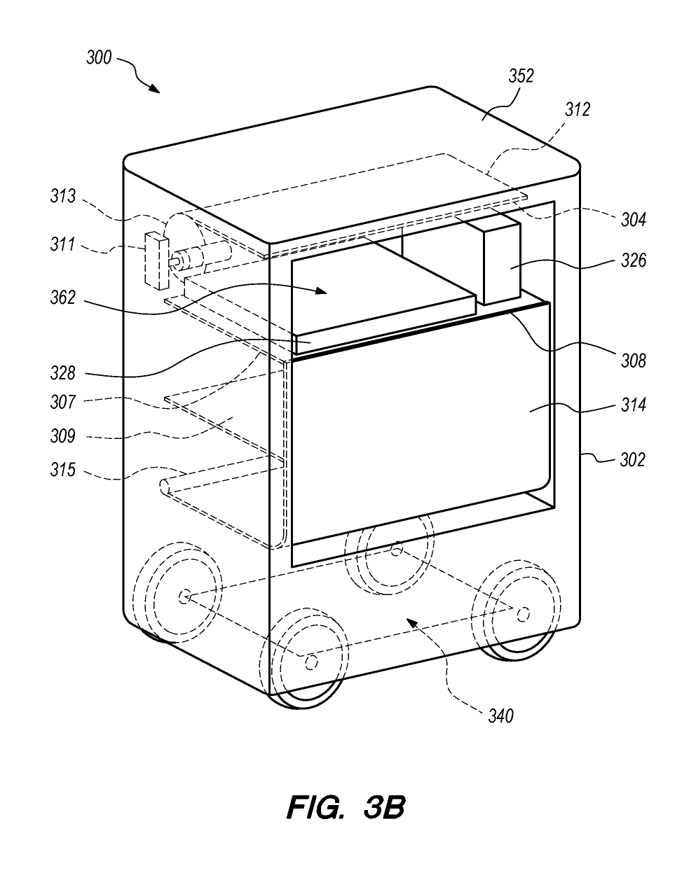

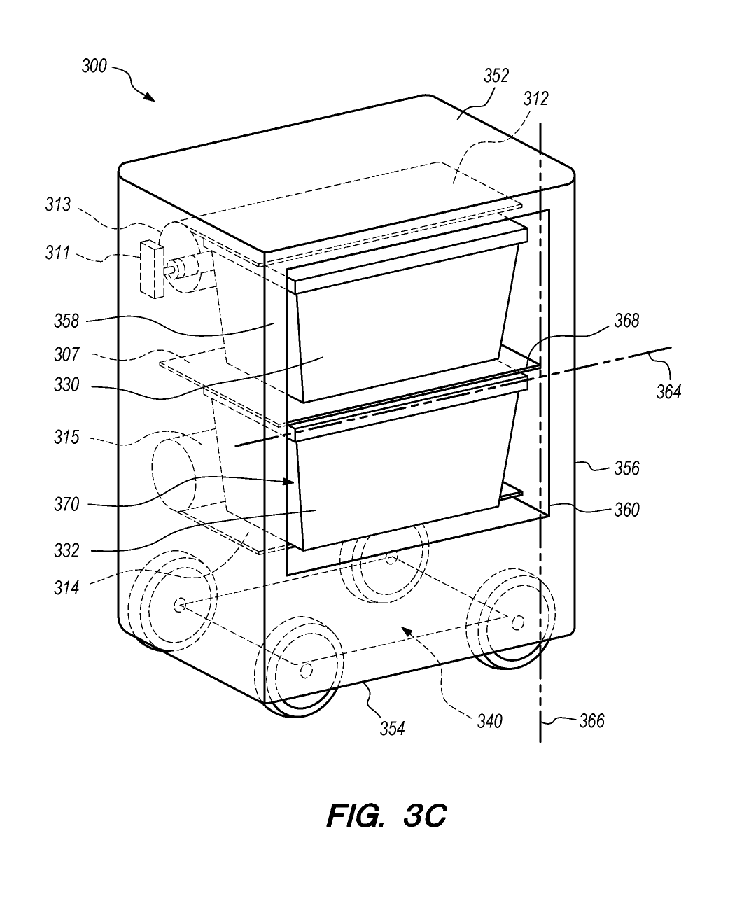

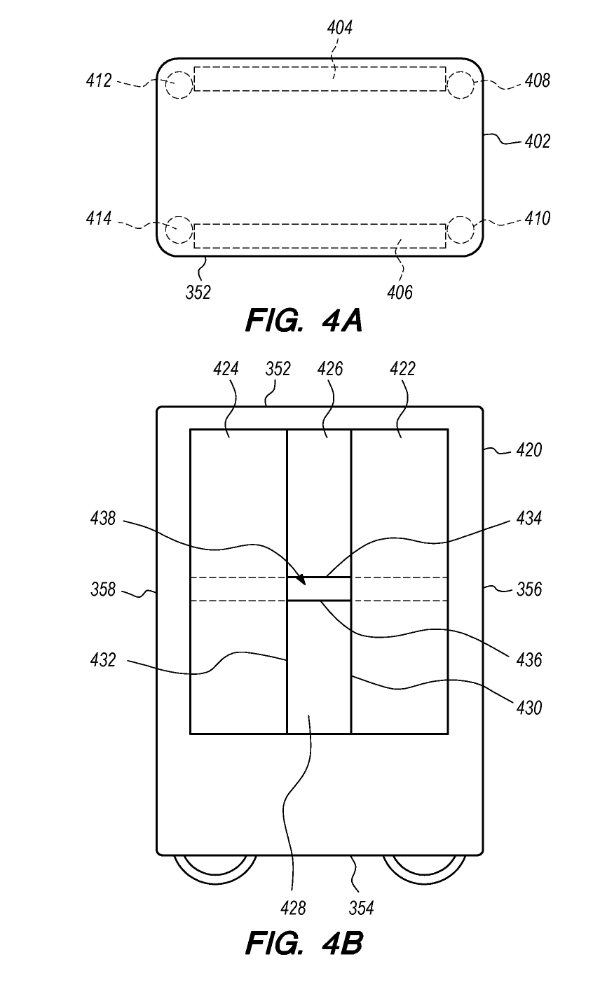

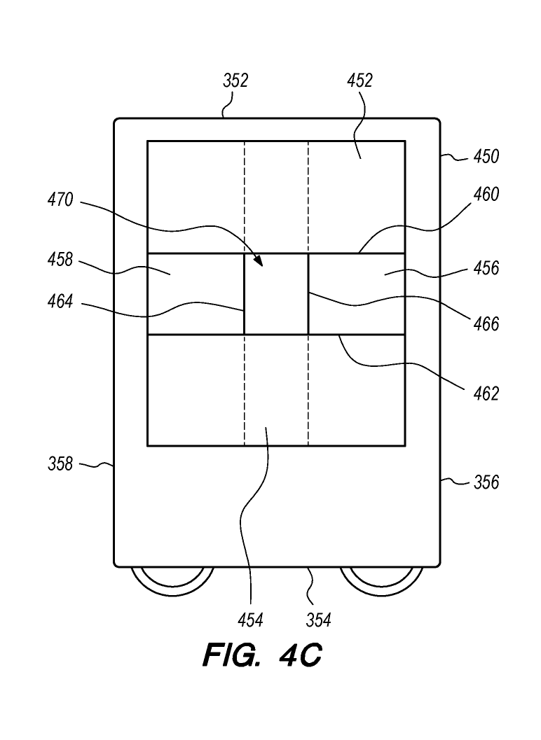

Example configurations of door assembly 140 are shown in FIGS. 3A-3C and FIGS. 4A-4C. In FIGS. 3A-3C and FIGS. 4A-4C, certain details are omitted so as not to obscure the aspects being portrayed. For example, structural details of and electrical connections between mobility subsystem 360, robot control system 170, door control subsystem 150, compartment scanning subsystem 160, drive(s) 152 and doors 142 are omitted.

In FIG. 3A, a robot 300 has a housing defined by a frame 302. Robot 300 is supported by a propulsion assembly 340, which illustratively includes electrically powered wheels (for simplicity, only the wheels are shown in the drawings). Within the housing are mechanical and electrical components of robot 300, which are configured to perform the features and functions described in this document, and at least one storage compartment. Frame 302 has a top side 352, a bottom side 354 and opposing vertical sides 356, 358. Horizontal and vertical dimensions of an interior region of robot 300 are defined by distances between opposing vertical sides 356, 358 and top side 352 and bottom side 354, respectively.

The example door assembly of robot 300 has a plurality of doors including two horizontal doors 312, 314 and two vertical doors 316, 318. Horizontal doors 312, 314 are configured to move up and down in a vertical direction along a y-axis relative to storage compartment 130 when robot 300 is supported above the floor (such as by propulsion assembly 340) and vertical doors 316, 318 are configured to move up and down in a horizontal direction along an x-axis relative to storage compartment 130. Door 312 has a leading edge 304. Door 314 has a leading edge 308. Door 316 has a leading edge 310. Door 318 has a leading edge 306. LED indicators 320 are optionally mounted to portions of the leading edges 304, 306, 308, 310 but for simplicity are only shown in the drawing as mounted to leading edge 304.

The positions of the leading edges 304, 306, 308, 310 define an opening in at least a portion of storage sub-compartment 322, which is carrying payload 324. The opening defined by the leading edges 304, 306, 308, 310 is adjustable in size by movement of the doors 312, 314, 316, 318. Door control subsystem 150 can use the map 162 to associate adjustments of the size of openings created by movement of the doors 312, 314, 316, 318 with adjustments in the sizes of the storage sub-compartments. In other words, door control subsystem 150 coordinates movement of doors 312, 314, 316, 318 with the current sub-compartment dimensions and adjusts the parameters used by drive mechanism(s) 152 (omitted from FIG. 3A for simplicity) to move the doors 312, 314, 316, 318 when the dimensions of the sub-compartments change. In this way, robot 102 can be programmed to open varying-sized sub-compartments selectively, to provide greater security for its payload.

In FIG. 3B, a different storage compartment, 362, has an opening that is defined by the positions of doors 312, 314, with doors 316, 318 being fully retracted into the housing of robot 300 (doors 316, 318 are omitted from FIG. 3B). Leading edges 304, 308 define the top and bottom boundaries of storage compartment 362 while the frame 302 defines the opposing side boundaries of storage compartment 362. Transition from the configuration of FIG. 3A to the configuration of 3B is accomplished by door control subsystem 150 operating drive mechanism(s) 152 to move the doors 312, 314, 316, 318 into different positions as shown. A simplified depiction of one implementation of a drive mechanism 152 is shown as motor 311, which rotates a spool bidirectionally to extend or retract door 312. A retracted portion 313 of door 312 wraps around the spool. A retracted portion 315 of door 314 is also shown in FIG. 3B, although the details of the corresponding drive mechanism are omitted for simplicity. Similar mechanisms can be implemented for each of the doors.

In FIG. 3B, shelves 307, 309 are mounted in the interior region of the robot. Illustratively, shelf 307 is positioned to support payload 326, 328. Shelves 307, 309 can be repositioned or removed completed as needed to support payload of different sizes and shapes.

In FIG. 3C, all of doors 312, 314, 316, 318 are fully retracted into the housing of robot 300, such that the opening into the storage compartment is at its maximum size. For simplicity, doors 316, 318 and portions of drive mechanisms 152 are omitted.

In the example of FIG. 3C, an adjustable shelf 307 is mounted within the interior region of the storage compartment such that the storage compartment is divided into two sub-compartments, with each sub-compartment carrying an item of payload 330, 332. The length and height dimensions of the two sub-compartments are defined by the position of the shelf 307. For instance, the intersection 360 of side 356 with side 354 defines a length of storage compartment 370, and the intersection 368 of shelf 307 and side 356 defines a height of the lower storage compartment 370.

FIG. 3C also illustrates axes 364, 366. Axis 366 is orthogonal to axis 364. For example, axis 364 is a horizontal axis and axis 366 is a vertical axis 366 when robot 102 is supported above the floor by mobility subsystem 340. As described above, opposing doors 312, 314 are movable along axis 366 while opposing doors 316, 318 are movable along axis 364 to adjust the size of the opening into the storage compartment or sub-compartment, as the case may be.

FIG. 4A shows a sectional view of top portion 352 of frame 302, showing a surface 402 and rollers 404, 406, 408, 410, 412, 414. Roller 406 retracts door 312 while rollers 410, 414 retract doors 316, 318, respectively. Door 314 is retracted by a roller similar to roller 406 but mounted to a surface of bottom edge 354 (which is not shown in FIG. 4A). A similar arrangement is used to retract doors on the opposite side of the robot housing, using rollers 404, 408, 412. Thus, robot 300 can have a door assembly 140 on both opposing sides of a storage compartment to facilitate access to the payload from either side of the robot.

FIGS. 4B and 4C illustrate alternative configurations of horizontal and vertical doors of a door assembly 420. In FIG. 4B, a top horizontal door has a portion 426 that is visible, with other portions hidden from view in the illustrated configuration because the top horizontal door is mounted to the robot housing behind the vertical doors 422, 424. Portion 426 is exposed to view and has a leading edge 434 which defines a top boundary of storage compartment 438. Similarly, a bottom horizontal door is obstructed from view except for portion 428 and leading edge 436, which defines a bottom boundary of storage compartment 438. Vertical doors 422, 424 are fully visible and their respective leading edges define opposing vertical boundaries of storage compartment 438.

In FIG. 4C, vertical doors 456, 458 are positioned behind horizontal doors 452, 454 and leading edges 464, 466 of the vertical doors 456, 458 define opposing side boundaries of storage compartment 470 while leading edges 460, 462 define opposing top and bottom boundaries of storage compartment 470.

The doors of door assembly 140 can be electronically or electromechanically opened and closed, or otherwise manipulated, under stored program control by door control subsystem 150 to provide or prevent access to storage compartments 130. The example door control subsystem 150 comprises one or more electronic circuits that receive signals from sensors or a microcontroller or microprocessor to control the operation of the components of door assembly 140. Any one or combination of the storage compartments 130 can be programmatically released for access, or locked for security, by door control subsystem 150 of robot 102, prior to, during, or after execution of a robotic transport task.

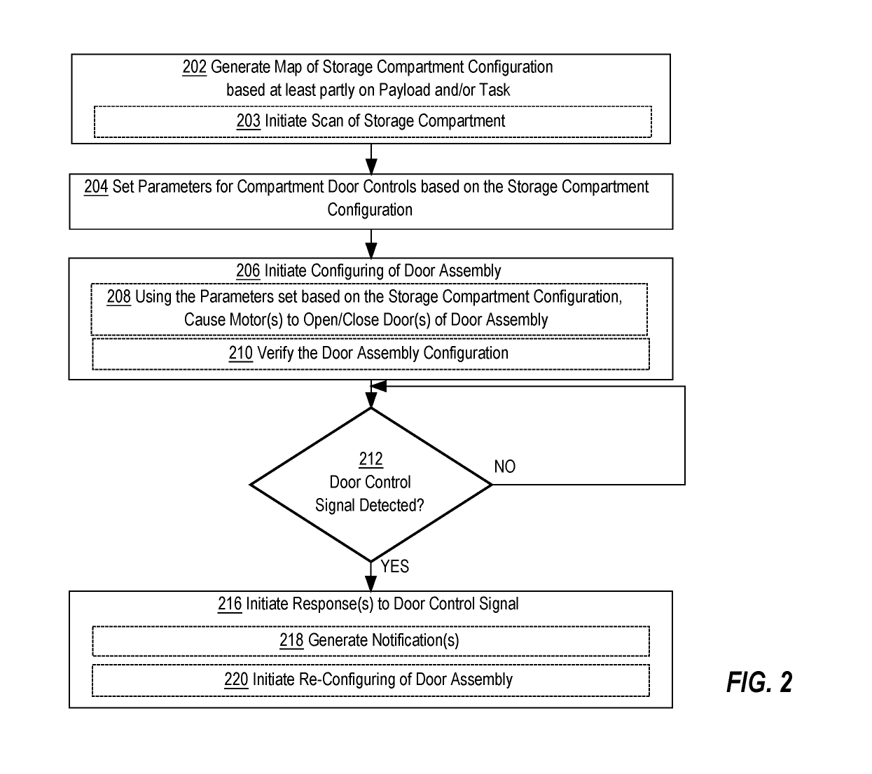

FIG. 2 is a flowchart of an example process for controlling operation of doors of a door assembly for a storage compartment of a robot. Aspects of the process are implemented as processor-executable instructions embodied in computer software, hardware, or a combination of hardware and software. In an embodiment, all or portions of a process 200 of FIG. 2 are performed by the robot 102 under program control, alone or in combination with one or more other computers of the computing environment 100. Thus, FIG. 2 is intended to disclose an algorithm, plan or outline that can be used to implement one or more computer programs or other software elements which when executed cause performing the functional improvements and technical advances that are described herein. Furthermore, FIG. 2 is described at a level of detail that persons of ordinary skill in the art ordinarily use to communicate with one another about algorithms, plans, or specifications forming a basis of software programs that they plan to code or implement using their accumulated skill and knowledge.

In operation 202 of FIG. 2, in an embodiment, the robot 102 generates a map of the current configuration of the robot's storage compartment (including an arrangement of sub-compartments within the storage compartment), where the configuration of the storage compartment is based at least partly on an attribute of a payload and/or a task of the robot. In doing so, robot 102 may initiate a scan of the storage compartment in operation 203, using, for example, technology implemented in compartment scanning subsystem 160.

In operation 204, robot 102 sets parameters for door control subsystem 150 to use to control operation of one or more doors of the door assembly, based on the storage compartment configuration that is determined in operation 202. In operation 206, robot 102 initiates configuration of the door assembly for the robot's storage compartment based on the control parameters that are set in operation 204. To do this, robot 102 or door control subsystem 150 may in operation 208 use the parameters set in operation 204 to generate control signals to drive mechanisms (such as motors) to cause all or some of the doors of the door assembly to move relative to the storage compartment (for example to extend or retract, to open or close the storage compartment). In operation 210, robot 102 may run a procedure to verify the door assembly configuration, for example by generating a new map of the storage compartment configuration and comparing it to the map that is generated in operation 202.

In operation 212, robot 102 waits for a door control signal to be received by, for example, door control subsystem 150. Examples of door control signals include sensor signals indicating the detection of a payload that needs to be loaded into a storage compartment of robot 102, sensor signals indicating that robot 102 has arrived at a destination at which a payload needs to be removed from a storage compartment of robot 102, or a control signal generated by robot control subsystem 170 commanding robot 102 to open or close a specific storage compartment.

In operation 216, robot 102 initiates an appropriate response to the door control signal detected in operation 212. An example of an appropriate response to the door control signal may include, in operation 218, generating one or more electronic notifications, such as a status notification sent to a display device of robot 102. A status notification may describe the door control signal that has been detected and/or the response to the control signal that will be undertaken by robot 102. Another example of an appropriate response to the door control signal may include, in operation 220, robot 102 initiating a re-configuring of the door to open or close a sub-compartment for loading or unloading a payload.

Implementation Example—Hardware Overview

According to one embodiment, the techniques described herein are implemented by at least one computing device. For example, portions of the disclosed technologies may be at least temporarily implemented on a network including a combination of at least one server computer and/or other computing devices. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

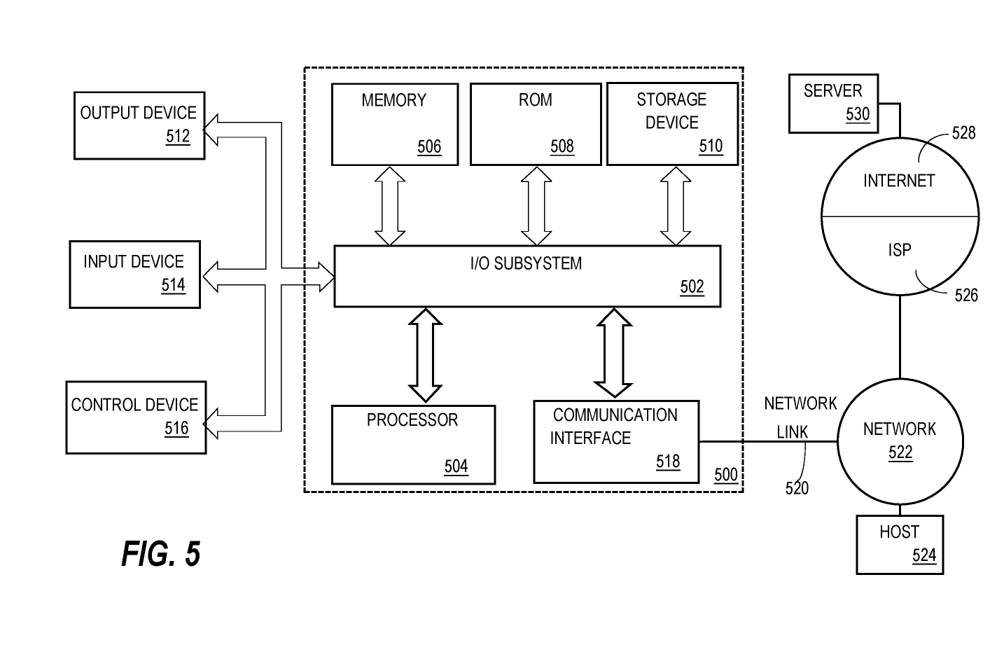

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and at least one I/O port. The electronic signal paths are represented schematically in the drawings, for example as lines, unidirectional arrows, or bidirectional arrows.

At least one hardware processor 504 is coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to at least one output device 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

At least one input device 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, at least one ASIC or FPGA, firmware and/or program logic which in combination with the computer system causes or programs computer system 500 to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to at least one communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through at least one network to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### ADDITIONAL EXAMPLES

Illustrative examples of the technologies disclosed herein are provided below. An embodiment of the technologies may include any at least one, and any combination of, the examples described below.

An example 1 includes a robot, including: a housing; a storage compartment defined in the housing; at least one sub-compartment defined in the storage compartment, the sub-compartment having an adjustable first dimension and an adjustable second dimension; first and second doors retractably coupled to the housing, the first door movable along a first axis of the storage compartment, the second door movable along a second axis of the storage compartment, the second axis orthogonal to the first axis; a drive mechanism coupled to the first and second doors, the drive mechanism operable to coordinate movement of the first door along the first axis and movement of the second door along the second axis with adjustments in the first and second dimensions of the sub-compartment.

An example 2 includes the subject matter of example 1, and includes first and second shelf members disposed in the storage compartment, the second shelf member meeting the first shelf member at a first intersection, the first intersection defining the length of the sub-compartment.

An example 3 includes the subject matter of example 2, and includes a third shelf member disposed in the storage compartment, the third shelf member meeting the second shelf member at a second intersection, the second intersection defining the width of the sub-compartment.

An example 4 includes the subject matter of any of examples 1-3, and includes first and second shelf members disposed in the storage compartment, the second shelf member meeting the first shelf member at a first intersection, the first intersection defining the width of the sub-compartment.

An example 5 includes the subject matter of example 2, and includes a third shelf member disposed in the storage compartment, the third shelf member meeting the second shelf member at a second intersection, the second intersection defining the length of the sub-compartment.

An example 6 includes the subject matter of any of examples 1-5, wherein the first and second doors are disposed in parallel planes.

An example 7 includes the subject matter of any of examples 1-6, and includes a third door retractably coupled to the housing, the third door coplanar with the first door and movable along the first axis of the storage compartment.

An example 8 includes the subject matter of any of examples 1-7, and includes a fourth door retractably coupled to the housing, the fourth door coplanar with the second door and movable along the second axis of the storage compartment.

An example 9 includes the subject matter of any of examples 1-8, wherein the drive mechanism is operable to open the sub-compartment by moving an edge of the first door to a first location defined by a coordinate on the first axis and to move an edge of the second door to a second location defined by the coordinate on the first axis and a coordinate on the second axis.

An example 10 includes the subject matter of any of examples 1-9, wherein the drive mechanism is operable to open the sub-compartment by moving an edge of the third door to a third location defined by a third coordinate on the first axis, a distance between the first and third coordinates on the first axis defining the first dimension of the sub-compartment.

An example 11 includes the subject matter of any of examples 1-10, wherein the drive mechanism is operable to open the sub-compartment by moving an edge of the fourth door to a fourth location defined by the coordinate on the first axis and a fourth coordinate on the second axis, a distance between the second and fourth coordinates on the second axis defining the second dimension of the sub-compartment.

An example 12 includes the subject matter of any of examples 1-11, and includes a sensor coupled to the housing, wherein the robot uses a signal from the sensor to determine the first dimension or the second dimension of the sub-compartment.

An example 13 includes the subject matter of any of examples 1-12, wherein the robot uses the first dimension or the second dimension of the sub-compartment to generate a map of the storage compartment.

An example 14 includes the subject matter of any of examples 1-14, wherein the sensor is coupled to the first door or the second door or to an interior region of the storage compartment.

An example 15 includes the subject matter of any of examples 1-14, and includes a light coupled to the first door or the second door.

An example 16 includes the subject matter of any of examples 1-15, wherein the drive mechanism comprises at least one electric motor disposed in the housing.

An example 17 includes the subject matter of example 8, wherein the drive mechanism is operable to close the sub-compartment by moving an edge of the first door to a first location defined by a first coordinate on the first axis and to move an edge of the third door to a second location defined by a second coordinate on the first axis, the second coordinate adjacent to the first coordinate on the first axis.

An example 18 includes the subject matter of example 17, and includes a sensor coupled to the first door or the third door, wherein the robot is configured to use a signal from the sensor to determine whether the sub-compartment is closed and lock the storage compartment when the sub-compartment is closed.

An example 19 includes the subject matter of example 8, wherein the drive mechanism is operable to close the sub-compartment by moving an edge of the second door to a first location defined by a first coordinate on the second axis and to move an edge of the fourth door to a second location defined by a second coordinate on the second axis, the second coordinate adjacent to the first coordinate on the second axis.

An example 20 includes the subject matter of example 19, and includes a sensor coupled to the second door or the fourth door, wherein the robot is configured to use a signal from the sensor to determine whether the sub-compartment is closed and lock the storage compartment when the sub-compartment is closed.

An example 21 includes the subject matter of any of examples 1-20, and includes a sensor coupled to the housing, wherein the robot uses a signal from the sensor to determine an attribute of a payload of the robot and use the attribute to determine the first dimension or the second dimension of the sub-compartment.

An example 22 includes the subject matter of example 21, wherein storage compartment comprises a plurality of sub-compartments and the robot uses the attribute of the payload to assign the payload to one of the plurality of sub-compartments.

An example 23 includes the subject matter of any of examples 1-22, and includes a sensor coupled to the housing or the first door or the second door, wherein the robot uses a signal from the sensor to detect an obstruction and when an obstruction is detected, stop movement of the first door or the second door.

General Considerations

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used herein the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

What is claimed is:

1. A robot, comprising:
a housing;
a storage compartment defined in the housing;
at least one sub-compartment defined in the storage compartment, the sub-compartment having an adjustable first dimension and an adjustable second dimension;
first and second doors retractably coupled to the housing, the first door movable along a first axis of the storage compartment, the second door movable along a second axis of the storage compartment, the second axis orthogonal to the first axis;
a drive mechanism coupled to the first and second doors, the drive mechanism operable to coordinate movement of the first door along the first axis and movement of the second door along the second axis with adjustments in the first and second dimensions of the sub-compartment.

2. The robot of claim 1, comprising first and second shelf members disposed in the storage compartment, the second shelf member meeting the first shelf member at a first intersection, the first intersection defining the length of the sub-compartment.

3. The robot of claim 2, comprising a third shelf member disposed in the storage compartment, the third shelf member meeting the second shelf member at a second intersection, the second intersection defining the width of the sub-compartment.

4. The robot of claim 1, comprising first and second shelf members disposed in the storage compartment, the second shelf member meeting the first shelf member at a first intersection, the first intersection defining the width of the sub-compartment.

5. The robot of claim 2, comprising a third shelf member disposed in the storage compartment, the third shelf member meeting the second shelf member at a second intersection, the second intersection defining the length of the sub-compartment.

6. The robot of claim 1, wherein the first and second doors are disposed in parallel planes.

7. The robot of claim 1, comprising a third door retractably coupled to the housing, the third door coplanar with the first door and movable along the first axis of the storage compartment.

8. The robot of claim 7, comprising a fourth door retractably coupled to the housing, the fourth door coplanar with the second door and movable along the second axis of the storage compartment.

9. The robot of claim 8, wherein the drive mechanism is operable to open the sub-compartment by moving an edge of the first door to a first location defined by a coordinate on the first axis and to move an edge of the second door to a second location defined by the coordinate on the first axis and a coordinate on the second axis.

10. The robot of claim 9, wherein the drive mechanism is operable to open the sub-compartment by moving an edge of the third door to a third location defined by a third coordinate on the first axis, a distance between the first and third coordinates on the first axis defining the first dimension of the sub-compartment.

11. The robot of claim 10, wherein the drive mechanism is operable to open the sub-compartment by moving an edge of the fourth door to a fourth location defined by the coordinate on the first axis and a fourth coordinate on the second axis, a distance between the second and fourth coordinates on the second axis defining the second dimension of the sub-compartment.

12. The robot of claim 1, comprising a sensor coupled to the housing, wherein the robot uses a signal from the sensor to determine the first dimension or the second dimension of the sub-compartment.

13. The robot of claim 12, wherein the robot uses the first dimension or the second dimension of the sub-compartment to generate a map of the storage compartment.

14. The robot of claim 1, wherein the sensor is coupled to the first door or the second door or to an interior region of the storage compartment.

15. The robot of claim 1, comprising a light coupled to the first door or the second door.

16. The robot of claim 1, wherein the drive mechanism comprises at least one electric motor disposed in the housing.

17. The robot of claim 8, wherein the drive mechanism is operable to close the sub-compartment by moving an edge of the first door to a first location defined by a first coordinate on the first axis and to move an edge of the third door to a second location defined by a second coordinate on the first axis, the second coordinate adjacent to the first coordinate on the first axis.

18. The robot of claim 17, comprising a sensor coupled to the first door or the third door, wherein the robot is configured to use a signal from the sensor to determine whether the sub-compartment is closed and lock the storage compartment when the sub-compartment is closed.

19. The robot of claim 8, wherein the drive mechanism is operable to close the sub-compartment by moving an edge of the second door to a first location defined by a first coordinate on the second axis and to move an edge of the fourth door to a second location defined by a second coordinate on the second axis, the second coordinate adjacent to the first coordinate on the second axis.

20. The robot of claim 19, comprising a sensor coupled to the second door or the fourth door, wherein the robot is configured to use a signal from the sensor to determine whether the sub-compartment is closed and lock the storage compartment when the sub-compartment is closed.

21. The robot of claim 1, comprising a sensor coupled to the housing, wherein the robot uses a signal from the sensor to determine an attribute of a payload of the robot and use the attribute to determine the first dimension or the second dimension of the sub-compartment.

22. The robot of claim 21, wherein storage compartment comprises a plurality of sub-compartments and the robot uses the attribute of the payload to assign the payload to one of the plurality of sub-compartments.

23. The robot of claim 1, comprising a sensor coupled to the housing or the first door or the second door, wherein the robot uses a signal from the sensor to detect an obstruction and when an obstruction is detected, stop movement of the first door or the second door.
